(19) United States
(12) Patent Application Publication
(10) Pub. No.: US 2025/0315559 A1
(43) Pub. Date: Oct. 9, 2025

(54) METHODS AND SYSTEMS FOR SECURE DEVICES

(71) Applicant: Morris Bouskila, BROOKLYN, NY (US)

(72) Inventor: Morris Bouskila, BROOKLYN, NY (US)

(21) Appl. No.: 19/089,522

(22) Filed: Mar. 25, 2025

Related U.S. Application Data
(60) Provisional application No. 63/631,021, filed on Apr. 8, 2024.

(51) Int. Cl. G06F 21/71

(52) U.S. Cl. CPC G06F 21/71

(57) ABSTRACT

The present invention relates to protecting the privacy and security of electronic and/or mobile devices. The present invention relates to protecting the hardware of electronic and/or mobile devices from potential hacking. The present invention relates to improved hardware, software and protocols for protecting electronic and/or mobile devices. The present invention relates to methods of using improved hardware, software and protocols for improving the privacy and security of electronic and/or mobile devices.

### CROSS-REFERENCE OF RELATED APPLICATION(S)

This application claims priority to U.S. Provisional Application No. 63/631,021, which was filed on Apr. 8, 2024, the contents of which are incorporated herein in their entirety.

### FIELD OF THE INVENTION

The present invention relates generally to improving the privacy and security of devices such as computers, mobile phones and other mobile devices. The present invention relates generally to improved hardware, software and protocols for improving the privacy and security of computers, mobile phones and other mobile devices. The present invention relates generally to methods of using improved hardware, software and protocols for improving the privacy and security of computers, mobile phones and other mobile devices.

### BACKGROUND OF THE INVENTION

A priority for all devices such as computers, mobile phones and other mobile devices, as well as their manufacturer, is privacy and security. However, electronic devices such as mobile phones can be hacked through a variety of methods that exploit vulnerabilities in the device's software or hardware. These vulnerabilities can be inherent to the operating system, the applications installed on the device, or even the underlying hardware components. As such, protecting a device's hardware and software from potential hacking attempts is critical.

One of the most common ways for hackers to gain access to a mobile phone is by tricking users into downloading and installing malicious apps. While these apps may appear legitimate, they may contain malware designed to exploit vulnerabilities in the device's operating system or other software components. Once installed, these apps can steal sensitive information, track the user's activities, or even take control of the device remotely.

Phishing attacks is a method where hackers trick users into revealing their login credentials or other sensitive information. These attacks typically involve sending fake emails, text messages, or social media messages that appear to be from legitimate sources such as banks or popular websites. When users click on links or enter their information into fake login forms, the hackers can capture this data and use it to access the victim's device or other accounts.

Like any other software, mobile operating systems and applications have vulnerabilities that may be exploited by hackers to gain unauthorized access to a device. This can involve using known security flaws to execute malicious code on the device, bypassing security mechanisms, or gaining escalated privileges to perform actions that are normally restricted.

Physical access is another method by which hackers may gain access to and physically compromise a device. This may involve stealing the device, accessing the device when the user is not present, for example via a Type C port on the device (also called USB-C), or exploiting other physical security weaknesses to gain entry. Once a hacker gains access to a device, they can use various techniques to extract data, install malware, or tamper with the device's software.

Reflashing, also known as flashing, involves replacing the operating system or firmware on a device (e.g., a mobile phone) with a modified or custom version. This can be done through various means, such as powering the phone off, connecting the phone to a computer (e.g. via a USB port and/or a USB-C port), and using specialized software or tools. A hacker may reflash a mobile phone to install custom firmware with backdoors or other malicious code, allowing them to gain persistent access to the device and control its functions remotely.

Accordingly, there is a need for improved methods, hardware, software and protocols for safeguarding such devices to prevent unauthorized access and to ensure user privacy, security, and data integrity. The present invention therefore relates to improved methods, protocols, hardware, circuitry and software for improving the privacy and security of devices such as computers, mobile phones and other mobile devices.

### SUMMARY OF THE INVENTION

In an exemplary embodiment, the present invention relates to protecting the privacy and security of devices. The present invention preferably relates to protecting devices from hacking. The present invention preferably relates to protecting devices from hacking via flashing or reflashing, preferably protecting a device's motherboard from flashing or reflashing.

### BRIEF DESCRIPTION OF THE DRAWINGS

FIG. 1 is an electronic device schematic according to an exemplary embodiment of the present invention.

### DESCRIPTION OF THE INVENTION

The present invention is described herein in exemplary form. The description herein is not intended to limit the scope of the invention or this patent. Rather, it is contemplated that the claimed subject matter might also be embodied in other ways, to include additional features or combinations of features similar to the ones described herein.

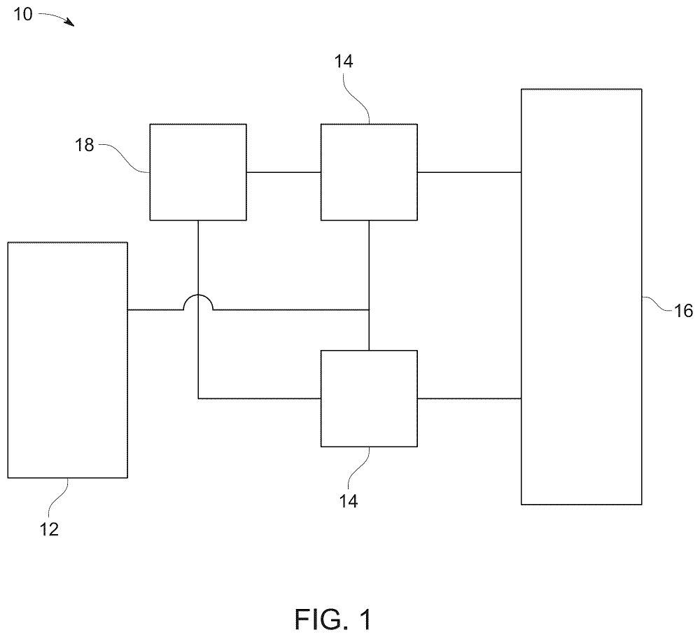

In an exemplary embodiment, the present invention is shown in FIG. 1 and is generally indicated by reference number 10. The present invention according to an exemplary embodiment may include a motherboard 12 and a security circuit 14. The present invention according to an exemplary embodiment may include a port 16, preferably a Type C port 16, preferably a USB-C port 16. The present invention according to an exemplary embodiment may include a multimedia switch 18, preferably a USB Type C multimedia switch 18.

With reference to FIG. 1, by way of example, the present invention may include a security circuit 14. By way of example, those of ordinary skill in the art will recognize that in electronics, a circuit is preferably composed of individual electronic components, through which electricity flows (e.g., via an electronic signal) flows. By way of example, a security circuit 14 may be configured to render the motherboard 12 inaccessible when the device is powered off. By way of example, the security circuit 14 may include a chip 14, preferably a chipset 14. By way of example, the security circuit 14 may preferably include a microchip 14.

With reference to FIG. 1, by way of example, the present invention may include a port 16, preferably a Type C port 16, preferably a USB-C port 16. By way of example, those of ordinary skill in the art will recognize the Type C port 16 and USB-C port 16 as a port for device charging and data transfer. By way of example, those of ordinary skill in the art will recognize the Type C port 16 and USB-C port 16 as the most popular charging and data transfer interface for Android devices.

With reference to FIG. 1, by way of example, the present invention may include a multimedia switch 18, preferably a USB Type C multimedia switch 18. By way of example, those of ordinary skill in the art will recognize multimedia switch 18 as an electronic switch capable of sending power (e.g., by providing an electric signal) to port 16. By way of example, those of ordinary skill in the art will recognize multimedia switch 18 as an electronic switch capable of sending power (e.g., by providing an electric signal) to the Type C port 16 and/or USB-C port 16. By way of example, those of ordinary skill in the art will recognize multimedia switch 18 as an electronic switch capable of turning off power (e.g., by terminating an electric signal) to port 16. By way of example, those of ordinary skill in the art will recognize multimedia switch 18 as an electronic switch capable of turning off power (e.g., by terminating an electric signal) to the Type C port 16 and/or USB-C port 16. In an exemplary embodiment of the present invention, the motherboard 12 may command a security circuit 14 to direct an electric signal to (or away from) multimedia switch 18 to thereby turn on (or turn off) the Type C port 16 and/or USB-C port 16.

With reference to FIG. 1, by way of example, the present invention may include a motherboard 12. By way of example, a motherboard 12 is the central circuit that houses and connects various components essential for the device's functionality. For example, a motherboard 12 may include a processor or central processing unit (CPU) that handles the devices computations and executes instructions; memory or RAM (Random Access Memory) that provides temporary storage for data and instructions that the CPU needs to access quickly; storage components such as eMMC (embedded MultiMediaCard) or UFS (Universal Flash Storage) which hold a device's operating system, apps, and user data; integrated circuits for cellular modem (for network connectivity like 4G/5G), Wi-Fi, Bluetooth, and sometimes NFC to facilitate communication and data exchange over different wireless networks; power management circuits to regulate the flow of electricity throughout the device to ensure the efficient use of battery power and the handling of charging processes; various sensors (e.g., accelerometer, gyroscope, proximity sensor) that enable features like screen rotation, gesture recognition, and ambient light detection; interfaces for physical connectors (e.g., USB-C, headphone jack); and security features such as secure boot mechanisms, cryptographic accelerators, and hardware-based encryption modules to protect user data and ensure the integrity of the device's software.

With reference to FIG. 1, by way of example, given their importance in many devices, motherboards 12 may be the targets of hacking or exploitation. Indeed, motherboards 12 have vulnerabilities including but not limited to firmware vulnerabilities, hardware trojans, BIOS/UEFI attacks, peripheral component vulnerabilities, and physical access, as discussed further below:

Firmware Vulnerabilities: Motherboards 12 contain firmware, such as the BIOS (Basic Input/Output System) or UEFI (Unified Extensible Firmware Interface), which may have vulnerabilities that hackers can exploit. Vulnerabilities in firmware may allow hackers to execute malicious code or gain unauthorized access to the system.

Hardware Trojans: Bad or malicious actors may attempt to compromise the manufacturing or supply chain of motherboards 12 to insert hardware-based backdoors or Trojans, which can be difficult to detect and allow attackers persistent access to systems.

BIOS/UEFI Attacks: Hackers may attempt to modify or replace the BIOS/UEFI firmware with malicious versions. This could potentially allow them to control the system from the base or root level, affecting its behavior and compromising its security.

Peripheral Component Vulnerabilities: Motherboards 12 connect and manage various peripheral components like network interfaces, USB ports 16, and expansion cards. Vulnerabilities in these components could be exploited to gain unauthorized access or execute attacks.

Physical Access: If a hacker gains physical access to a system, the hacker may attempt to manipulate or modify the motherboard 12 directly. This could involve installing hardware implants or modifying existing components to facilitate unauthorized access or data exfiltration.

Motherboards 12, as recognized by exemplary embodiments of the present invention, are especially vulnerable to hacking or exploitation because typically a motherboard 12 does not completely turn off when a device is powered down or off. By way of example, when you turn off a device phone using the power button or through the operating system's shutdown command, the system undergoes a process called “soft shutdown.” By way of example, a device “soft shutdown” may typically include the following: (1) Operating System Shutdown: where the operating system (OS) running on the phone initiates shutdown procedures, such as closing all running apps, saving user data, and performing any necessary cleanup tasks; (2) Power to Components: the operating signal sends signals to various components (such as the CPU, memory, and other integrated circuits) to power down or enter low-power states, to help conserve battery power when the phone is not in use, and (3) Standby Mode: after the shutdown process completes, the phone enters a standby or low-power mode, where some components may still receive a minimal amount of power to maintain their settings or to be ready for a quick startup when the phone is turned on again.

By way of example, with reference to FIG. 1, while a device may be turned off, the motherboard 12 typically remains operational in such a low-power state to facilitate quick startup and maintain necessary functions. This is so the motherboard 12 may continue to manage power distribution, maintain data integrity, and control essential functions even when the phone is powered off. Such a design ensures that the phone can efficiently manage power consumption while still being ready for user interaction when powered on again. Indeed, to achieve a complete power off where the motherboard 12 and all components receive no power, you typically need to remove the battery (if removable) or disconnect the phone from any power source, including any connected USB cables.

With reference to FIG. 1, by way of example, a motherboard 12 typically remains operational in a low-power state, even when a device is powered off or turned off. As such, the device remains susceptible to “hacking” or “rooting” via flashing (reflashing) in order to gain control over its features and functions. By way of example, “flashing” or “reflashing” a device (e.g., a mobile phone, smartphone, computer, etc.) typically refers to replacing the operating system (OS) or firmware (e.g., BIOS firmware) of the device with a new, different or modified version. The firmware is typically stored on a chip on the motherboard 12 itself and is essential for initializing hardware components during the boot-up process of a computer. By way of example, a hacker may connect a mobile phone or smartphone via a USB cable from the phone's Type C port 16 to a computer where flashing software has been pre-installed. The flashing software typically guides the process, prompting the hacker to select the firmware they want to install. By way of such flashing or reflashing, a hacker may gain complete control of the device, for example a smartphone or mobile phone.

Accordingly, in one exemplary embodiment, the present invention relates to protecting a device from hacking or rooting attacks. Preferably, the present invention relates to protecting a device from flashing or reflashing by hackers. By way of exemplary embodiment, the present invention may include any one or more of the following components:

With reference to FIG. 1, by way of example, the present invention may include a device. In one exemplary embodiment, the device is preferably an electronic device. By way of example, the device may be computers, laptops, tablets, mobile phones, cellphones, smartphones, televisions, gaming consoles, streaming devices, fitness trackers, blood pressure monitors, pulse oximeters, refrigerators, washing machines and dryers, microwaves, speakers, headphones and earphones, microphones, CCTV cameras, doorbell cameras, car infotainment systems, engine control units (ECUs), collision avoidance systems, smartwatches, smart glasses, health monitoring devices, weather stations, air quality monitors. In one exemplary embodiment, the device of the invention is preferably a mobile phone, cell phone or smartphone.

With reference to FIG. 1, by way of example, the present invention may include a motherboard 12. By way of example, a motherboard 12 may distribute electricity and facilitate communication between and to a central processing unit (CPU), random access memory (RAM), and any other component of the computer's hardware. There is a broad range of types of motherboards 12, each of which is intended to be compatible with a specific type of device.

By way of example, a motherboard 12 may work in accordance with the following exemplary embodiment. When a device is turned on, a power supply transfers electricity to motherboard 12 to be used by the device. Data is transported between the chipset (microchip) components via data buses and travels between what are referred to by those of ordinary skill in the art as the southbridge and northbridge chipset. Data connections to the CPU, RAM, or PCIe are made through the northbridge chipset. The operations performed by the RAM are first “interpreted” by the CPU as being output after the RAM begins to deliver inputs to the CPU. After being written to the PCIe, the data is either copied or moved to the expansion card, based on the kind of card you have. The data connection to the BIOS system, the universal serial bus (USB), the serial advanced technology attachment (SATA), and the PCI bus are managed by the southbridge chipset. A device is able to start up because of signals sent to the BIOS, and the data sent to the SATA “awakens” the optical, hard disc, and solid-state drives. The video card, network card, and sound card receive power from the information stored on the SATA. The remaining components interact via an electrical signal, which serves as a hub for them. These data buses pass via a microchip's northbridge or southbridge elements, which then branch off to other components like the CPU, RAM, PCI, and PCIe, amongst other elements. The information sent over buses will be encoded using a programming language. When a signal is sent to a motherboard 12 from one of its components, the motherboard 12 will process it and translate it into a language the other component can comprehend. On most of today's computing systems, all of this will occur in a split second, and there is almost no delay between the input and the output.

With reference to FIG. 1, by way of example, a motherboard 12 of the invention may be inaccessible, preferably configured to be inaccessible. By way of example, a motherboard 12 may be rendered inaccessible by removing all power to the motherboard 12 and/or turning off or powering down the motherboard 12. For example, rather than remaining operational in a regular or low-power mode, an inaccessible motherboard 12 is typically without power and completely powered down and/or turned off. Being without power and turned off, a motherboard 12 is inaccessible in that a hacker (or others) is unable to access the motherboard 12 through typical techniques, for example via flashing software installed on a computer that is connected to a device (e.g., via a USB cable).

With reference to FIG. 1, by way of exemplary embodiment, a motherboard 12 is inaccessible by powering off the motherboard 12 when the device is powered off. By way of exemplary embodiment, a security circuit 14 renders the motherboard 12 inaccessible by powering off the motherboard 12 when the device is powered off. By way of exemplary embodiment, the security circuit 14 comprises at least one microchip 14. By way of exemplary embodiment, the security circuit 14 comprises at least one microchip 14 located on the motherboard 12.

With reference to FIG. 1, by way of example, the motherboard 12 of the invention may be accessible, preferably configured to be accessible. By way of exemplary embodiment, the motherboard 12 is configured to be accessible by powering on the motherboard 12 when the device is powered on. By way of example, a motherboard 12 may be rendered accessible by providing power to the motherboard 12 and/or turning on or powering up the motherboard 12. For example, a motherboard 12 may be accessible when operational in a regular or low-power mode. With power and turned on, a motherboard 12 may be accessible in that a hacker (or others) is able to access the motherboard 12 through typical techniques, for example via flashing software installed on a computer that is connected to a device (e.g., via a USB cable).

With reference to FIG. 1, by way of exemplary embodiment, the motherboard 12 may be inaccessible via port 16, preferably Type C Port 16, when the device is powered off. By way of example, when the device is powered off, the motherboard 12 may be rendered inaccessible by directing an electrical signal through at least one security circuit 14 and away from multimedia switch 18. By way of example, when the device is powered off, the electrical signal is directed through at least one security circuit 14 and away from multimedia switch 18. In one exemplary embodiment, when the device is powered off, the motherboard 12 commands that the electrical signal is sent through at least one security circuit 14 and away from multimedia switch 18. In this way, by way of example, when the device is powered off, the multimedia switch 18 does not power on (turn on) port 16, preferably Type C port 16, and therefore motherboard 12 is not accessible via port 16, preferably Type C port 16. Those of ordinary skill in the art will recognize that when the motherboard 12 is inaccessible via port 16, preferably Type C port 16, the device including the motherboard 12 is protected from hacking via methods such flashing or reflashing.

With reference to FIG. 1, by way of exemplary embodiment, the motherboard 12 may be accessible via port 16, preferably via Type C Port 16, when the device is powered on. By way of example, when the device is powered on, the motherboard 12 may be rendered inaccessible by directing an electrical signal to multimedia switch 18. By way of example, when the device is powered on, the electrical signal is direct to multimedia switch 12 and to port 16, preferably Type C port 16, thereby turning on port 16, preferably Type C port 16. In one exemplary embodiment, when the device is powered on, the motherboard 12 directs that the electrical signal be sent to the multimedia switch 12 and to port 16, preferably Type C port 16, thereby turning on port 16, preferably Type C port 16. In this way, by way of example, when the device is powered on, the multimedia switch 12 powers on port 16, preferably Type C port 16, and the device and the motherboard 12 are accessible via port 16, preferably Type C port 16.

With reference to FIG. 1, by way of exemplary embodiment, the present invention includes an electronic device. By way of example, the electronic device includes a motherboard 12 and a security circuit. By way of example, the motherboard 12 is configured to be inaccessible when the device is powered off. By way of example, the security circuit is configured to render the motherboard 12 inaccessible when the device is powered off. By way of example, the motherboard 12 is inaccessible by powering off the motherboard 12 when the device is powered off. By way of example, the security circuit renders the motherboard 12 inaccessible by powering off the motherboard 12 when the device is powered off. By way of example, the motherboard 12 is configured to be accessible by powering on the motherboard 12 when the device is powered on. By way of example, the security circuit comprises at least one microchip. By way of example, the security circuit comprises at least one microchip located on the motherboard 12.

By way of further example, with further reference to FIG. 1, the motherboard 12 is preferably configured to be inaccessible by powering off the motherboard 12 when the device is powered off. By way of example, the security circuit 14 is preferably configured to render the motherboard 12 inaccessible via port 16, preferably Type C port 16, when the device is powered off. By way of example, the security circuit 14 is preferably configured to direct an electric signal away from port 16, preferably Type C port 16, when the device is powered off. By way of example, the motherboard 12 is preferably configured to be accessible by powering on the motherboard 12 when the device is powered on. By way of example, the security circuit 14 is preferably configured to direct an electric signal to port 16, preferably Type C port 16, when the device is powered on. By way of example, the device is preferably a mobile phone, preferably a cellphone or smart phone.

With reference to FIG. 1, by way of exemplary embodiment, the present invention includes a system for securing a device. By way of example, the system includes a motherboard 12 and a security circuit. By way of example, the system includes a motherboard 12 configured to be inaccessible when the device is powered off. By way of example, the system includes a security circuit configured to render the motherboard 12 inaccessible when the device is powered off. By way of example, the system includes a motherboard 12 that is inaccessible by powering off the motherboard 12 when the device is powered off. By way of example, the system includes a security circuit that renders the motherboard 12 inaccessible by powering off the motherboard 12 when the device is powered off. By way of example, the system includes a motherboard 12 is configured to be accessible by powering on the motherboard 12 when the device is powered on. By way of example, the system includes a security circuit that comprises at least one microchip. By way of example, the system includes a security circuit that comprises at least one microchip located on the motherboard 12. By way of example, the device that is a mobile phone.

By way of further example, with further reference to FIG. 1, the motherboard 12 is preferably configured to be inaccessible by powering off the motherboard 12 when the device is powered off. By way of example, the security circuit 14 is configured to render the motherboard 12 inaccessible via port 16, preferably via Type C port 16, when the device is powered off. By way of example, the security circuit 14 is configured to direct an electric signal away from port 16, preferably Type C port 16, when the device is powered off. By way of example, the motherboard 12 is configured to be accessible by powering on the motherboard 12 when the device is powered on. By way of example, the security circuit 14 is configured to direct an electric signal to port 16, preferably Type C port 16, when the device is powered on.

With reference to FIG. 1, by way of exemplary embodiment, the present invention includes an operating method for securing a device. By way of example, the device comprises a motherboard 12, preferably a motherboard 12 is configured to be inaccessible when the device is powered off. By way of example, the device comprises a security circuit, preferably a security circuit is configured to render the motherboard 12 inaccessible when the device is powered off. By way of example, the operating method comprises rendering the motherboard 12 inaccessible when the device is powered off. By way of example, the operating method comprises the security circuit rendering the motherboard 12 inaccessible by powering off the motherboard 12 when the device is powered off. By way of example, the operating method comprises the motherboard 12 being configured to be accessible when the device is powered on. By way of example, the operating method comprises rendering the motherboard 12 accessible when the device is powered on. By way of example, the operating method comprises the security circuit rendering the motherboard 12 accessible by powering on the motherboard 12 when the device is powered on. By way of example, the security circuit comprises at least one microchip. By way of example, the security circuit comprises at least one microchip located on the motherboard 12. By way of example, the device is a mobile phone.

By way of further example, with further reference to FIG. 1, the method preferably further comprise the security circuit 14 rendering the motherboard 12 inaccessible by powering off the motherboard 12 when the device is powered off. By way of example, the method preferably further comprises the security circuit 14 rendering the motherboard 12 inaccessible via port 16, preferably via Type C port 16, when the device is powered off. By way of example, the method preferably further comprises the security circuit 14 directing an electric signal away from port 16, preferably Type C port 16, when the device is powered off. By way of example, the method preferably further comprises the security circuit 14 rendering the motherboard 12 accessible by powering on the motherboard 12 when the device is powered on. By way of example, the method preferably further comprises the security circuit 14 directing an electric signal to port 16, preferably Type C port 16, when the device is powered on. By way of example, the method preferably further comprises the security circuit 14 directing an electrical signal away from port 16, preferably Type C port 16, when the device is powered off.

Those of ordinary skill in the art will recognize the numerous advantages provided by the present invention, for example as compared to the prior art. By way of one example, the present invention provides for improved security and privacy of an electronic device by rendering the device and its motherboard 12 inaccessible to hackers via port 16, preferably via Type C port 16, when the device is turned off. In this way, for example, the present invention is able to protect devices and their operation, as well as user data, from hacker attacks such as flashing and reflashing.

While aspects of the present invention are described herein and illustrated in the accompanying drawings, those of ordinary skill in the art will appreciate that the invention, in its broadest aspects, has further applicability.

It will be appreciated that the above description is merely exemplary in nature and is not intended to limit the present disclosure, its application or uses. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

We claim:

1. An electronic device that comprises:
a motherboard,
a security circuit,
the motherboard configured to be inaccessible when the device is powered off,
the security circuit configured to render the motherboard inaccessible when the device is powered off.

2. The electronic device of claim 1, wherein the motherboard is configured to be inaccessible by powering off the motherboard when the device is powered off.

3. The electronic device of claim 1, wherein the security circuit is configured to render the motherboard inaccessible via a port when the device is powered off.

4. The electronic device of claim 1, wherein the security circuit is configured to direct an electric signal away from a port when the device is powered off.

5. The electronic device of claim 1, wherein the motherboard is configured to be accessible by powering on the motherboard when the device is powered on.

6. The electronic device of claim 1, wherein the security circuit is configured to direct an electric signal to a port when the device is powered on.

7. The electronic device of claim 1, wherein the device is a mobile phone.

8. A system for securing a device, the system comprising:
a motherboard,
a security circuit,
the motherboard configured to be inaccessible when the device is powered off,
the security circuit configured to render the motherboard inaccessible when the device is powered off.

9. The system of claim 8, wherein the motherboard is configured to be inaccessible by powering off the motherboard when the device is powered off.

10. The system of claim 8, wherein the security circuit is configured to render the motherboard inaccessible via a port when the device is powered off.

11. The system of claim 8, wherein the security circuit is configured to direct an electric signal away from a port when the device is powered off.

12. The system of claim 8, wherein the motherboard is configured to be accessible by powering on the motherboard when the device is powered on.

13. The system of claim 8, wherein the security circuit is configured to direct an electric signal to a port when the device is powered on.

14. An operating method for securing a device:
the device comprising:
a motherboard, wherein the motherboard is configured to be inaccessible when the device is powered off,
a security circuit, wherein the security circuit is configured to render the motherboard inaccessible when the device is powered off,
the operating method comprising:
rendering the motherboard inaccessible when the device is powered off.
rendering the motherboard accessible when the device is powered on.

15. The method of claim 14, further comprising the security circuit rendering the motherboard inaccessible by powering off the motherboard when the device is powered off.

16. The method of claim 14, further comprising the security circuit rendering the motherboard inaccessible via a port when the device is powered off.

17. The method of claim 14, further comprising the security circuit directing an electric signal away from a port when the device is powered off.

18. The method of claim 14, further comprising the security circuit rendering the motherboard accessible by powering on the motherboard when the device is powered on.

19. The electronic device of claim 14, further comprising the security circuit directing an electric signal to a port when the device is powered on.

20. The electronic device of claim 14, further comprising the security circuit directing an electrical signal away from a port when the device is powered off.
